(19) United States
(12) Patent Application Publication
(10) Pub. No.: US 2002/0164984 A1
(43) Pub. Date: Nov. 7, 2002

(54) System and method for providing location-specific services to mobile users using an IP network

(76) Inventor: Kaushal Thakker, Irving, TX (US)

Correspondence Address: Arthur I. Navarro, Navarro IP Law Group, Suite 655, 801 E. Campbell Rd, Richardson, TX, 75081, US

(21) Appl. No.: 09/847,072

(22) Filed: May 2, 2001

(51) Int. Cl. H04Q 7/20

(52) U.S. Cl. 455/435; 455/414; 455/426

(57) ABSTRACT

A telecommunications system (10) supporting load sharing between a Public Land Mobile Network (8) and an Internet Protocol network (14) within a shared service area (20) includes an air interface to the IP network (14) for providing IP network service to mobile terminals (28a, 28b). Location-specific services to PLMN mobile terminals in the service area supported by the IP network are enabled.

### TECHNICAL FIELD

The invention relates in general to wireless telecommunication networks and applications and, in particular, to methods and systems for location-specific load sharing and service enhancements to public land mobile networks (PLMNs). More particularly, the invention relates to methods and systems for dynamic supplementation of a PLMN network enabling location-specific services for users of PLMN mobile terminal.

### BACKGROUND OF THE INVENTION

PLMNs are commonly employed to provide wireless voice and data communications to authorized subscribers using individual mobile terminals. For example, PLMNs using Code Division Multiple Access (CDMA) and Time Division Multiple Access (TDMA), as well as other communication protocols, have been introduced, providing voice services to their subscribers using TDMA or CDMA mobile terminals. Despite advances in PLMN technology, in high traffic locations, subscribers often experience loss of service or dropped calls due, in part, to network congestion. The addition of PLMN infrastructure to accommodate high traffic conditions in particular locations can be an expensive proposition. Moreover, service providers hesitate to add equipment that may soon become obsolete due to advances in technology.

Apart from increased demand, another problem of present day PLMN systems is the inability to provide location-specific services. By design a PLMN is uniform platform across a coverage area, providing system-wide services, which are not easily targeted to a particular location. For example, information relative to the subscriber's current location, e.g.; mall, grocery store, airport, etc., cannot be provided to the subscriber through current PLMN infrastructure as the subscriber moves from one location served by the PLMN to another.

Accordingly, a means of supplementing the current PLMN infrastructure would provide numerous advantages. Moreover, a means of easing congestion that offered location-specific services would expand the use of the network and provide many useful applications for subscribers moving from one network location to another.

### SUMMARY OF THE INVENTION

The invention provides systems, methods, and apparatus, in the form of an IP network, for load sharing between a PLMN and the IP network such that the resources of the IP network are used within a service area served by both the PLMN and the IP network. As a result, the solution provides the ability to deliver site specific services to subscribers of the PLMN via a standard mobile terminal.

Accordingly, disclosed is a method of providing site specific services to a mobile terminal within an area serviced by both a wireless network and an Internet Protocol (IP) network. The method comprises the steps of the IP network providing an air interface to the wireless network and a mobile terminal registering with the IP network via the air interface thereby allowing the IP network to share the load of servicing the mobile terminal. Next, the mobile terminal requests service and the IP network provides service to the mobile terminal such that the mobile terminal performs as if it were being serviced by the wireless network. In this way, services handled by the IP network can be delivered to the mobile terminal as it roams into an area served by both the wireless and IP networks.

Also disclosed is a telecommunications system providing load sharing between a wireless Public Land Mobile Network (PLMN) and an Internet Protocol (IP) network. The system comprises a Public Land Mobile Network (PLMN) configured to provide wireless service to mobile terminals throughout a specified service area and an Internet Protocol network adapted to provide service within a shared service area of the specified service area. An interface for operably coupling the Internet Protocol (IP) network to the the PLMN is provided such that the IP network is configured to detect service requests from mobile terminals of the PLMN and wherein the IP network is further configured to provide said mobile terminals.

Further disclosed is an Internet Protocol (IP) network supporting the provision of site specific services to mobile terminals of a PLMN. The IP network comprises a Radio Base Station (RBS) providing an air interface for coupling a mobile terminal of a PLMN to the IP network and a Network Access Controller (NAC) configured to provide the functions of a Mobile Switching Center/Visitor Location Register thereby enabling registration of mobile terminals according to standard procedures of the PLMN. A Service Node (SN) is configured to provide location specific services to the mobile terminal, the location specific services related to a service area shared by both the PLMN and the IP network.

Technical advantages realized by the invention are numerous and include the relief of network congestion levels in a PLMN without additional PLMN infrastructure. In short, the PLMN gains increased capability for servicing more mobile terminals with increased reliability.

A further advantage of the invention is that location-specific services may be provided with the service area of the IP network such that mobile terminal users can receive information specific to a location in which the mobile terminal is being serviced. This permits the selective provisioning of IP network services to PLMN customers within a location-specific service area according to customer characteristics or immediate service needs.

### BRIEF DESCRIPTION OF THE DRAWINGS

The above advantages, as well as specific embodiments of the present invention, will be more clearly understood from consideration of the following descriptions in connection with accompanying drawings in which:

FIG. 1 is a block diagram illustrating an example of a system of supplementing a Public Land Mobile Network (PLMN) with an Internet Protocol (IP) network according to the invention;

FIG. 2 is a block diagram showing an example of the architecture of an IP network of the invention; and

FIG. 3 is a process flow diagram of the method of the invention of FIGS. 1 and 2.

Corresponding numerals and symbols in the various figures refer to corresponding parts unless otherwise indicated.

### DETAILED DESCRIPTION OF PREFERRED EMBODIMENTS

While the making and using of various embodiments of the present invention are discussed in detail below, it should be appreciated that the present invention provides many applicable inventive concepts which can be embodied in a wide variety of specific contexts. It should be understood that the invention may be practiced with IP networks and PLMNs of various types and locations. Some features of embodiments shown and discussed are simplified or exaggerated for illustrating the principles of the invention.

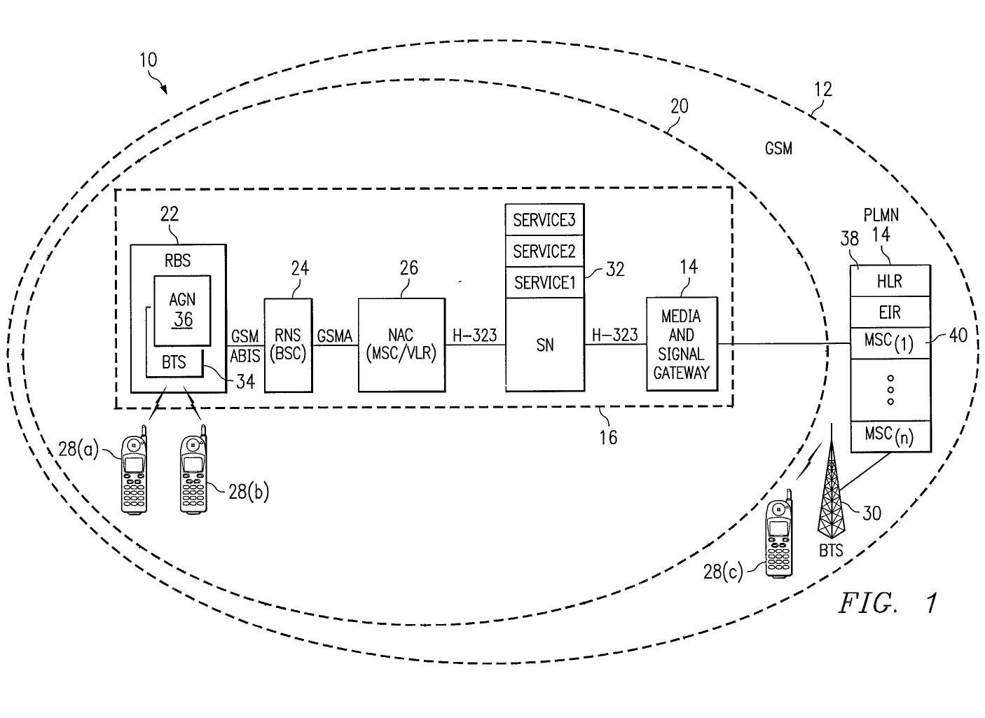

With reference to FIG. 1, therein is shown a telecommunications system, denoted generally as 10, according to the invention. The system 10 includes a Public Land Mobile Network (PLMN) 8 operating within a PLMN service area 12 and one or more IP-based network(s) 14 that are configured to provide service within an area shared by both the PLMN 8 and the IP network(s) 14 (i.e. “shared service area 20”). As explained below, the PLMN 8 and IP network 14 (the singular and plural forms will be used interchangeably throughout) are both capable of providing service to any one of a plurality of mobile terminals 28a, 28b within the shared service area 20, that exists within the PLMN service area 12. A media and signaling gateway 16 transfers the IP signaling and payload from the IP network 14 to the PLMN 8.

Thus, the system 10 of the invention can be used in a shared service area 20 within the PLMN service area 12. Preferably, the shared service area 20 is located within a smaller geographic area than the PLMN service area 12 such that high call volume or location-specific services may be provided at a specific location encompassed by the shared service area 20. For example, the shared service area 20 may generally correspond to a particular premises such as an airport, shopping mall, or sports facility. By allowing the IP network 14 to service mobile terminals 28a:28b, specific information relevant to location in which the mobile is being serviced can be provided (for example, flight information, sales prices, or correct scores, etc.) To the mobile terminal 28a:28b.

Although a Global System for Mobile communication systems (GSM) PLMN 8 is shown and described with respect to the preferred embodiment, the invention may be practiced with PLMN topologies such as, for example, wireless network using Code Division Multiple Access (CDMA), Enhanced Data for GSM Evolution (EDGE), and Digital Advanced Mobile Phone Service (DAMPS). The system 10 has access to an IP network 14 serving, and typically geographically located within or adjacent to, the shared service area 20. The IP network 14 operates using an Internet Protocol known in the arts such as, for example, H.323. An example of an H.323 IP network with which the invention may advantageously be used is “GSM on the Net” available from Telephonaktiebolaget L. M. Ericsson of Sweden. Of course, other IP networking standards and protocols may also be used.

The IP network 14 contains a Radio Base Station (RBS) 22, a Radio Network Server (RNS) 24, and a Network Access Controller (NAC) 26. The RBS 22 is configured to provide air interface services to PLMN mobile terminals 28(a), 28(b) within the shared service area 20. Note that additional mobile terminals such as, in this example, 28(c) may exist within the PLMN service area 12, but outside of the shared service area 20. With respect to mobile terminals 28(a) and 28(b), the RBS 22 of the IP network 14 emulates a PLMN Base Transceiver Station (BTS) 30 compatible with mobile terminals 28(a), 28(b) and 28(c), in this case, GSM. The IP network 14 also preferably includes a Service Node (SN) 32 for interfacing the RBS 22, RNS 24, NAC 26, the IP network 14, and the media and signaling gateway 16. The implementation of a service node complying with these requirements can be readily achieved by those skilled in the art.

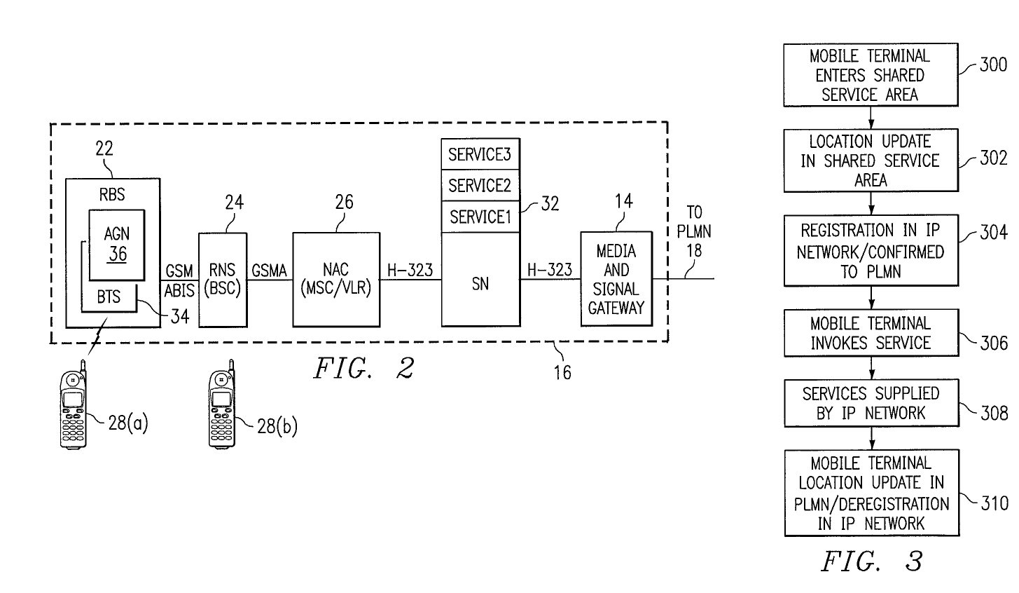

FIG. 2 shows an example of the preferred architecture of the IP network 14. The RBS 22 preferably has a Base Transceiver Station (BTS) 34 and an Abis Gateway (AGW) 36. Of course, the invention may be practiced with a PLMN architecture other than GSM, such as Wideband CDMA (WCDMA), without departing from the essential aspects of the invention so long as an IP network/PLMN interface is provided so that the mobile terminals may interact with the IP network 14 as if it were an air interface component of the PLMN 8, and the PLMN 8 may interface with the IP network 14 as though it were a mobile-servicing station of the PLMN 8.

In this example, the RBS 22 is configured to provide mobile terminals within the shared service area 20, e.g., mobile terminals 28(a) and 28(b), are provided with a GSM air interface. The Radio Network Server (RNS) 24 is connected to the RBS 22 for performing radio frequency signal processing and for controlling the RBS 22 operation. The RNS 24 includes functionality corresponding to a typical GSM Base Station Controller (BSC) as is well known in the arts. The Network Access Controller (NAC) 26 is connected to the RNS 24 and configured to convert signals between a wireless protocol, GSM in the present example, and IP protocol, such as H.323, for facilitating the transmission of signals between the IP network 14 and the mobile terminals 28(a), 28(b). The NAC 26 network interface includes MSCNLR functionality as found in a GSM PLMN.

The Service Node (SN) 32 is able to access service information made available using the resources of the IP network 14. Typically, the IP network 14 operator provides mobile telephone service to mirror the service of the PLMN 8, and also provides location-specific services not offered by the PLMN 8 outside of the shared service area 20. The NAC 26 preferably provides the necessary protocol conversion for IP/wireless interfacing, in this case between H.323 and GSM.

In general, referring to FIGS. 1 and 2, when a mobile terminal, for example mobile terminal 28(a) enters the shared service area 20, the NAC 26 registers the mobile terminal 28(a) with the IP network 14, and also updates the Home Location Register (HLR) 38 of the PLMN 8, according to GSM mobility management procedures. The mobile terminal 28(a) is then capable of being served by the IP network 14 for its typical PLMN 8 services, and is also capable of accessing any additional location-specific services offered via the IP network 14. The private IP network 14 thus emulates a Mobile Switching Center/Visitor Location Register (MSCNLR), e.g., 40(n), of the PLMN 8. As a result, the PLMN 8 may be relieved from providing services to the mobile terminal 28(a) as long as it remains registered with the IP network 14 in the shared service area 20.

A fuller understanding of the invention can be obtained by an example with further reference to FIGS. 1 and 2. For the sake of example, it is assumed that mobile terminal 28(a) is a subscriber served by a GSM PLMN 8 and has moved into the shared service area 20. Upon a location update by the mobile terminal 28(a) in the shared service area 20, the Network Access Controller (NAC) 26 performs the necessary PLMN registration procedures appropriate to the terminal type. In this case, the GSM mobile terminal 28(a) is identified with its HLR 38 through NAC 26 communication via the media and signaling gateway (MSGW) 16 of the IP network 14. The mobile terminal 28(a) is then registered with the Service Node (SN) 32 for the use of the resources available in the shared service area 20.

Assuming that mobile terminal 28(a) is then used in an attempt to place a call, the invention would operate as follows: The mobile terminal 28(a) user attempts to initiate service by, for example, entering a telephone number and pressing a call activation button. The RBS 22 detects the service request event which is an event predefined for the system 10 such as, for example, an attempt to place a call while inside the shared service area 20, an attempt to activate particular services from a mobile terminal within the shared service area 20, or a particular event or condition designated by the operator of PLMN 8, such as a state of mobile traffic congestion. Upon the occurrence of a service request event, in this case the attempt to place a call while within the shared service area 20, the RBS 22 sends appropriate messages to the RNS 24 and to the NAC 26.

It should be understood that the system 10 of the invention, using the RBS 22, interfaces with the mobile terminal 28(a) as if it were an MSCNLR 40(n) of the PLMN 8. The system of the invention 10 also interfaces with the PLMN 8 as if the system 10 were an MSC/VLR 40(n) of the PLMN 8. It should be clear that the air interface between the IP network 14 and the mobile terminal 28(a) is self-contained within the RBS 22. In the case of a GSM system 10, the RBS 22 has the appropriate BTS 34 and AGW 36. Of course, variations in hardware are possible without departing from the primary aspects of the invention. It should also be understood that the call is carried beyond the air interface by the IP network 14 alone, and not by the PLMN 8.

As should be understood from the foregoing example, the PLMN 8 is able to serve callers within the shared service area 20 by the provision of an IP network 14 for functioning as a supplement to the PLMN 8. Depending on the preferences of the PLMN operator, shared services provided by the IP network 14 may extend to all mobiles within the shared service area 20, or to only particular mobiles, or to mobiles requesting particular services within the shared service area 20. In this way, the IP network 14 and system 10 of the invention can share the service load with the PLMN 8.

In addition to load sharing in the sense supplementing the PLMN 8 for the handling of an increased number of mobile terminals 28, or an increased volume of calls, the invention can be used to provide location-specific services to mobile terminals 28(a), 28(b) within the shared service area 20. The shared service area 20 can be areas of particularly heavy mobile terminal usage, or areas of specialized service requirements, or a combination of both. For example, if the shared service area 20 corresponds with the premises of an airport or a portion of an airport, the location-specific services provided by the invention may include flight schedules, weather information, and travel or region-specific advertising. It is contemplated that location-specific services may constitute virtually any data or communication services that may be made available to mobile terminals. Typically, such services are specific to a particular premises or location. Another example of location-specific services is an instance where the shared service area 20 roughly corresponds to a sports facility wherein the PLMN 18 operator may, for example, find it desirable to offer sports scores, statistics, information, or advertising which would be impractical or unprofitable to offer on a PLMN-wide basis.

An additional example of the operation of the invention may be understood with further reference primarily to FIG. 1. Assuming the shared service area 20 is a sports facility, a mobile terminal 28(b) within the shared service area 20 may request statistics concerning the performance of a particular player or team. The request would be treated as a service request event as predetermined by the PLMN 8 network and operator of system 10. Data responsive to the service request event is collected and, assuming that it is a preprogrammed location-specific service offered by the operator of the system 10, is provided by the SN 32 to the NAC 26 and, in turn, to the RBS 22 for transmission to the mobile terminal 28(b).

A process flow diagram of the method of the invention is shown in FIG. 3. The process flow of FIG. 3 corresponds with the above examples discussed with reference to FIGS. 1 and 2. After entering the shared service area in step 300, a mobile terminal performs a location update at step 302. The NAC registers the mobile terminal with the IP network, step 304. Thus, the IP network performs mobility management functions as if it were part of the PLMN, emulating, in the case of GSM, a Visitor Location Register (VLR), and informs the PLMN of the location of the mobile terminal.

When the mobile terminal originates a call or otherwise invokes service, shown at step 306, the IP network provides services for the call, step 308. For example, services may include communication services mirroring those of the PLMN, or location-specific services such as scores, schedules, advertisements and the like, step 308. When the mobile terminal leaves the coverage area of the IP network but remains in the PLMN service area, it performs a location update, step 310. Accordingly, the mobile terminal is handed off from the IP network to the PLMN using well known hand-off techniques.

The embodiments shown and described above are only exemplary. Even though numerous characteristics and advantages of the present invention have been set forth in the foregoing description together with details of the method of the invention, the disclosure is illustrative only and changes may be made within the principles of the invention to the full extent indicated by the broad general meaning of the terms used in the attached claims.

We claim:

1. A method of providing services to a mobile terminal within an area serviced by both a wireless network and an Internet Protocol (IP) network, comprising the steps of:
the IP network providing an air interface to the wireless network;
a mobile terminal registering with the IP network via the air interface thereby allowing the IP network to share the load of servicing the mobile terminal;
a mobile terminal requesting service; and
the IP network providing service to the mobile terminal.

2. The method of claim 1 further comprising the step of providing the wireless terminal with location-specific service.

3. The method of claim 1 further comprising the step of the mobile terminal performing a location update with the IP network.

4. The method of claim 1 further comprising the step of the IP network registering the mobile terminal with the wireless network.

5. The method of claim 1 further comprising the step of the IP network registering the mobile terminal in a Visitor Location Register (VLR).

6. The method of claim 1 further comprising the step of the IP network interfacing with the wireless terminal in emulation of the wireless network.

7. The method of claim 1 further comprising the step of the IP network interfacing with the wireless network in emulation of a Mobile Switching Center (MSC).

8. A telecommunications system providing load sharing between a wireless Public Land Mobile Network (PLMN) and an Internet Protocol (IP) network comprising:
a Public Land Mobile Network (PLMN) configured to provide wireless service to mobile terminals throughout a specified service area;
an Internet Protocol network adapted to provide service within a shared service area of said specified service area; and
an interface for operably coupling the Internet Protocol (IP) network to the the PLMN;
wherein said IP network is configured to detect service requests from mobile terminals of the PLMN and wherein said IP network is further configured to provide said mobile terminals.

9. The system according to claim 8 wherein the IP network utilizes H.323 protocol.

10. The system according to claim 8 wherein the PLMN is a Global System for Mobile (GSM) network.

11. The system according to claim 8 wherein the IP network further comprises a Radio Base Station (RBS) configured to provide an air interface to mobile terminals of the PLMN.

12. The system according to claim 11 wherein the IP network further comprises a Network Access Controller (NAC) configured to provide the functions of a Mobile Switching Center/Visitor Location Register enabling registration of mobile terminals according to standard PLMN procedures.

13. The system according to claim 12 wherein said IP network includes at least one Service Node (SN) configured to provide location specific services to mobile terminals, said location specific services related to said shared service area.

14. The system according to claim 13 wherein said IP network comprises a Radio Network Server configured to provide the base station controller functions of a PLMN within said shared service area.

15. An Internet Protocol (IP) network supporting the provision of site specific services to mobile terminals comprising:
a Radio Base Station (RBS) providing an air interface for coupling a mobile terminal of a Public Land Mobile Network (PLMN) to the IP network;
a Network Access Controller (NAC) configured to provide the functions of a Mobile Switching Center/Visitor Location Register thereby enabling registration of mobile terminals according to standard procedures of the PLMN; and
a Service Node (SN) configured to provide location specific services to said mobile terminal, said location specific services related to a service area shared by both said PLMN and said IP network.

16. The IP network according to claim 15 wherein the RBS further comprises a Base Station Transceiver (BTS).

17. The IP network according to claim 16 wherein the RBS further comprises an Abis Gateway (AGW).

18. The IP network according to claim 15 further comprising a Media and Signaling Gateway (MSGW) operably coupled to the NAC.

19. The IP network according to claim 15 wherein the IP network supports H.323 protocol.

20. The IP network according to claim 15 wherein the PLMN is a Global System for Mobile communication systems (GSM) network.

21. The IP network according to claim 16 wherein the IP network is configured to emulate a PLMN base station compatible with the mobile terminal.

22. The IP network according to claim 16 wherein the IP network emulates a mobile switch compatible with the PLMN.
